(19) United States
(12) Patent Application Publication
(10) Pub. No.: US 2013/0297425 A1
(43) Pub. Date: Nov. 7, 2013

(54) QUICK TRANSACTION COMPLETION USING MOBILE DEVICE

(71) Applicant: PAYTEL, INC., San Francisco, CA (US)

(72) Inventor: Resh Wallaja, San Francisco, CA (US)

(73) Assignee: Paytel, Inc., San Francisco, CA (US)

(21) Appl. No.: 13/870,856

(22) Filed: Apr. 25, 2013

Related U.S. Application Data
(60) Provisional application No. 61/687,976, filed on May 4, 2012.
(60) Provisional application No. 61/786,013, filed on Mar. 14, 2013.

(51) Int. Cl. G06Q 20/32

(52) U.S. Cl. CPC G06Q 20/3226
USPC 705/14.64; 705/44

(57) ABSTRACT

Upon receiving an indication that a user wishes to conduct a financial transaction with an online retailer, the user's identity is determined. Instead of requiring the user to create and log into an account with the online retailer, the user's identity may be determined from an identity framework generated for the user from at least one of a plurality of sessions the user is in. A mobile device identifier, such as a mobile phone number associated with the user's identity framework is then retrieved. The mobile device identifier is then used to complete the financial transaction, providing a measure of security. A one-step or two-step request is transmitted to the mobile device having the associated mobile device identifier to authorize the financial transaction. Upon receiving authorization from the mobile device for the financial transaction, the financial transaction can then be enabled.

### CROSS-REFERENCE TO RELATED APPLICATIONS

This application claims a benefit of, and priority to, U.S. Provisional Patent Application No. 61/687,976, filed on May 4, 2012, entitled “SYSTEMS AND METHODS FOR SINGLE ACTION MUTUAL AUTHENTICATION, IDENTITY, AND AUTHORIZATION SERVICE”, which is incorporated by reference in its entirety. The application also claims a benefit of, and priority to, U.S. Provisional Patent Application No. 61/786,013, filed on Mar. 14, 2013, entitled “QUICK TRANSACTION COMPLETION USING MOBILE DEVICE”, which is incorporated by reference in its entirety.

### BACKGROUND OF THE DISCLOSURE

1. Field of the Disclosure

The disclosure relates generally to e-commerce, and more particularly, to systems and methods for using a mobile device to facilitate electronic payments.

2. General Background

Selling and buying online has required the creation of commerce sites and then requiring the user to interact with the site to buy a particular product. In setting up an item for sale the merchant has to create or list on a commerce site. The commerce site must incorporate a user registration and identity framework and integrate with a payment gateway. The merchant will then have to attract the buyer to the listing location for a transaction to start. Merchants wish to be able to reach their customers on multiple channels, this is typically done via online advertising campaigns. However, when a buyer views an advertisement, the buyer must perform a sequence of steps that typically involves clicking away from the current ad-displaying site and navigate to the merchant's site. Upon arriving at the merchant site, and when shopping online with a merchant, a buyer must perform a sequence of discrete actions. For example, the buyer usually creates an account (selecting a unique user name or if using an email address for identity, verifying the email address) with the merchant, logs in to the account (typically involving many key strokes, and entering a password) , enters details of a funding source (typically a bank or credit card), provides billing address, etc. The buyer places an order at the merchant's site by clicking a “Send Order” (or similar) button on a “Review Order” (or similar) webpage during checkout. The merchant sends the authorization request to a payment processor, which in turn sends the authorization request to the issuing bank (or credit card association). If approved, the buyer is taken to an order confirmation page. On the retail merchant side, the merchant typically has to invest in creating and setting up a security compliant database, without which the customer has to type in the payment card information each time a new transaction is initiated.

When shopping with one merchant, the user can create an account and store user preference data, such as payment information, with the retail site. However, most users shop online with several different merchants, and therefore, must create several different accounts and remember several different user names and passwords, which can be cumbersome, inconvenient, and prone to security risks (as passwords can be stolen or harvested). Meanwhile sellers wish to be able to minimize the steps involved in converting an advertisement or a product listing into a converted sale, they want to be able to sell securely with few steps. Therefore, a need exists for a payment solution that overcomes the disadvantages described above with conventional payment methods.

### BRIEF DESCRIPTION OF THE DRAWINGS

By way of example, reference will now be made to the accompanying drawings, which are not to scale.

Figures (FIGS.) 1A and 1B illustrate block diagrams of systems for implementing some example embodiments.

FIG. 2A (FIG.) is a flow example of a single-step authorization process using a user's mobile device according to some example embodiments.

FIG. 2B is a flow chart of a dual-step authorization process using a user's mobile device according to some example embodiments.

FIG. 2C is a flow chart of a method for initiating a transaction from an advertisement, according to some example embodiments.

FIG. 3 is a block diagram of a database structure for storing user account data in accordance with certain example embodiments.

FIGS. 4A-4I are examples of screenshots in accordance with certain example embodiments.

FIG. 5 is a block diagram of a computing device in accordance with certain example embodiments.

FIG. 6 is a block diagram of a mobile device in accordance with certain example embodiments.

FIGS. 7A and 7B are block diagrams of a user registration process in accordance with example embodiments.

### DETAILED DESCRIPTION

Those of ordinary skill in the art will realize that the following description is illustrative only and not in any way limiting. Other embodiments will readily suggest themselves to such skilled persons, having the benefit of this disclosure, and the general principles defined herein may be applied to other embodiments and applications without departing from the spirit and scope of the disclosed configurations. Thus, the disclosure is not intended to be limited to the embodiments shown, but is to be accorded the widest scope consistent with the principles and features disclosed herein. Reference will now be made in detail to specific implementations as illustrated in the accompanying drawings. The same reference numbers will be used throughout the drawings and the following description to refer to the same or like parts.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

In some embodiments, an identity framework creates a unique user identity and links one or more identities to a user's mobile device identity. In one example, the mobile device is a mobile phone having an associated mobile phone number. The associated mobile phone number is indicated by a user as being able to authorize the user's online financial transaction.

In some embodiments, a request is transmitted to the mobile device to provide authorization for a transaction. In one embodiment, a request transmitted to the mobile device includes a request for completion of a physical act on the mobile device by the user. The completion of the physical act provides some assurance that the user is in possession and control of the mobile device associated with the user's identity framework. In one embodiment, the request includes verifying a human cognitive function, such a request for depressing a soft button or sliding a key. In another embodiment, the request includes a request for completion of a touch screen gesture. In another embodiment, the request includes a request for entry of a password. In another embodiment, the request includes a request for entry of secret PIN. In another embodiment, the request includes a request for a single action that involves both touch and identification, such as drawn pattern. In another embodiment, the request includes a biometric identification request, such as voice or facial recognition through audio recording or image capture.

In some embodiments, the type of physical act requested and/or a number of physical acts requested depend on such factors as, the type of financial transaction and/or amount thereof.

In one embodiment, at least two types of user input are requested from the user using their mobile device to complete the online financial transaction. The first request includes a request for completion of a simple physical act on the mobile device by the user. For example, the simple physical act may be to depress a soft button or complete a touch screen gesture, such as a swipe. The completion of the simple physical act may act to provide some assurance that the user is in possession and control of the mobile device associated with the user's identity framework. The second request may include a request for more sensitive user information, such as a user pin, password, ATM, etc., that provides verification of the user's identity.

In another embodiment, a request is transmitted to the mobile device to provide authorization for a transaction through biometric verification. This ensures that the mobile device user is authorized to use the mobile device for completing a financial transaction. The user's identity may be verified through audio recordings (e.g., voice recognition) or image/video capture (e.g., facial recognition) performed in response to the transmitted request. The acquired audio, image, or video file may be processed by a biometrics recognition software to verify the identity of the user using the mobile device.

In one embodiment, upon receiving an indication that a user using a computing device wishes to conduct a new user registration or online financial transaction with an online retailer, the user's identity is created or determined. Instead of requiring the user to create an account and then log into an account with the online retailer, the user's identity may be created and determined from an identity framework generated for the user from at least one of a plurality of sessions the user is in. Thus, for example, a user's identity may be gleaned from a session the user is currently in with, for example, an identity provider such as, a social network site and/or an electronic mail (email) application. For added security and ease of access, a mobile device identifier 136 associated with the user's identity framework is associated and later retrieved for verifying the transaction. A mobile device associated with the retrieved mobile device identifier 136 is used to complete the verification of the user or financial transaction. A request is transmitted to the mobile device to authorize access or the financial transaction. Upon receiving authorization from the mobile device for the access or financial transaction, the access or financial transaction can then be enabled. For example, stored payment information (e.g., bank card, credit card, PAYPAL account information) can be used to complete a payment or the user may be authenticated. The user is not required to perform any steps on their computing device after indicating that they wish to access a service or conduct the online financial transaction. All remaining steps requiring user input are conducted using the user's mobile device.

In one example embodiment, a seller can create a product listing, and indicate graphically an area within the product listing for the user to interact with in order to either create a new user registration or a initiate a financial transaction. In some embodiments, the product listing is an online graphical advertisement that has a recognizable area that a consumer can interact with. In another example the listing could be textual.

In some example embodiments, methods and systems for creating a product listing that can be transacted from an advertisement, or third party site, enabling a secure registration framework that links a person's identity to a physical mobile identity and finally enabling a financial transaction using the user's mobile device having an associated mobile device identifier are described herein.

In one example embodiment, the creation of product listing comprises of specifying co-ordinates of an area that the user must interact with to initiate a transaction.

Turning now to FIG. 1A, it illustrates a system 100 according to an example embodiment. System 100 includes a user (or client) device 110, a merchant server 140, an identity server 106 and a transaction processor 170 in communication over a network 160. A user 105, such as a sender or consumer, utilizes user device 110 to initiate a transaction at a merchant server 140, such as at a retail web site. Note that transaction, as used herein, refers to any suitable action performed using the user device, including payments, transfer of information, display of information, new user registration, etc. According to an example embodiment, transaction processor 170 utilizes user's mobile device 135 to complete the transaction, as further described herein.

User device 110, merchant server 140, and transaction processor 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a tablet, personal digital assistant (PDA), laptop computer, a smart television, and/or other types of computing devices capable of transmitting and/or receiving data over network 160.

User device 110 may include one or more browser applications 115 which may be used, e.g., to provide a convenient interface to permit user 105 to browse information available over network 160. For example, in one embodiment, browser application 115 may be implemented as a web browser configured to view information available over the Internet, including accessing a social networking site, a web email client, etc.

In one embodiment, user 105 may use a mobile device 135 (e.g., cellular phone) in communication with a mobile communication network (not shown), having a mobile device identifier 136, e.g., a mobile phone number, an IDEN number, etc. associated therewith. In another example, the mobile device identifier is an International Mobile Station Equipment Identity (IMEI) number, and the mobile device is a 3GPP (e.g., GSM, UMTS and LTE) or Integrated Digital Enhanced Network (iDEN) mobile phone. Mobile device 135 may optionally include one or more browser applications 116 which may be used, e.g., to provide a convenient interface to permit user 105 to browse information available over network 160. For example, in one embodiment, browser application 116 may be implemented as a web browser configured to view information available over the Internet, including accessing a social networking site, a web email client, etc.

User mobile device 135 may further include a client side payment application 120 which, in one embodiment, may be provided by transaction processor 170 (e.g., may be downloaded to user mobile device 135) and may be used, e.g., to provide client-side processing for performing desired tasks in response to operations selected by user 105. In one embodiment, client-side payment application 120 may have a unique identifier and is uniquely tied to a mobile device identifier 136 associated with user mobile device 135. In one embodiment, client application 120 may display a user interface in connection with a financial transaction initiated by user 105 using browser application 115 (executing on user device 110) as further described herein, in another embodiment it may show access details. In some embodiments, user device 110 and user mobile device 135 may be the same device. For example, if the user device 110 is registered in the user's identity framework as the authorized mobile device 135, then the request for a financial transaction authorization is sent to the user device 110. Thus, the user 105 may be able to start a transaction on the user device 110, have the transaction authorization request sent to the same user device 110, and complete the transaction on the user device 110.

Associated with user 105 are one or more identifiers 113 (e.g., username and password pairs) that the user 105 is currently using to access one or more websites and content available using user device 110 via network 160, including email sites, social networking sites, etc. For example, user 105 may currently be using a first username and password to access a social media account, e.g., FACEBOOK account, a second username and password to access an email account, e.g., a GMAIL account, a third username and password to access an online retailer, and so on. One or more of the identifiers 113 may be stored locally on the client device 110, e.g., in cookies or a cache associated with browser application 115 and may be capable or being used to authenticate the User 105 from a central identity server 106 across multiple sites and identities. A identity record is created by identity match module 158 and stored in user information database 180 and uniquely associated with a mobile device identifier 136.

In some embodiments, user identity aggregation is performed by a user aggregation module 107 executing on an identity server 106, such as a third-party identity provider. In some embodiments, user aggregation module 107 comprises software to aggregate a user's provisioned identities 113 from the user device 110. Identity aggregation module 107 communicates with transaction processor 170 and merchant server 140 to pass identity information in order to facilitate a registration or a payment transaction. One embodiment of aggregation module 107 may be browser pop-up or an overlay, a browser plugin, a browser tool bar, etc.

Merchant server 140 may be maintained, e.g., by a merchant or seller offering various products and/or services in exchange for payment to be received over network 160. Merchant server 140 may be used for point of sale (POS) or online purchases and transactions. Generally, merchant server 140 may be maintained by anyone or any entity that provides an Internet based service including those that receive money, which includes charities as well as retailers and restaurants. Merchant server 140 may also refer to an entity listing an advertisement for a product or service. Merchant server 140 may include a marketplace application 150 configured to serve information over network 160 to browser 115 of user device 110. For example, merchant server 140 may cause a webpage to be displayed via browser application 115 on a display associated with user device 110. The webpage may contain content, such as information about a product for sale. Merchant server 140 may maintain, e.g., a product database 182 containing information of products or merchandise or content that is available for purchase with “Buy Button”.

In one embodiment, the buy button module 155 executing on transaction processor 170 provides new user registration and causes registration information to be stored in user database 180. A user selecting a Buy Button causes buy button module 155 to cause invocation of identity aggregation module 107 which aggregates user's provisioned identities on user device 110. Identity aggregation module 107 communicates this information to transaction processor 170, where identity match module 158 causes a user record to be created in user information database 180.

In one embodiment, a “Buy Button” interface module 156 on the merchant server 140 provides a checkout or payment function, called herein a “Buy Now” button or “Buy Button”. In another embodiment, a buy button module 155 on transaction processor 170 provides the “Buy Button,” which can be embedded or otherwise inserted into content in a web page enabled by merchant server 140 on user device 110. “Buy Button” may be embedded in an advertisement, e.g., a pop-up advertisement, or may be part of a social media feed, such as a TWITTER feed, or may be part of email content, application data etc., as served by merchant server 140.

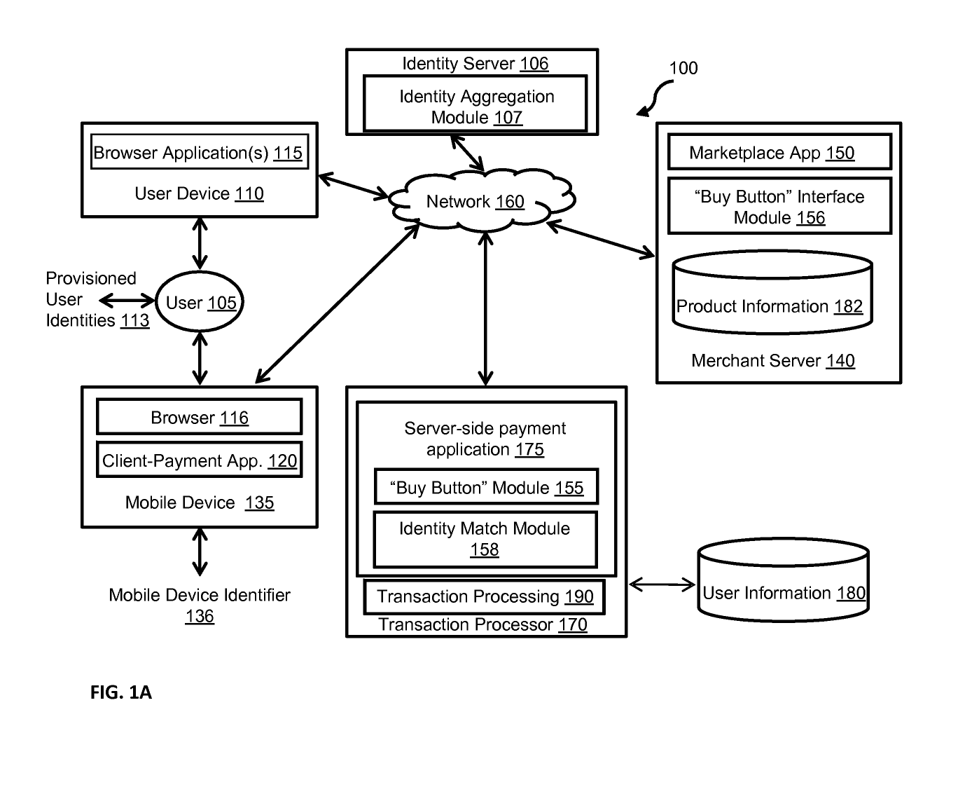

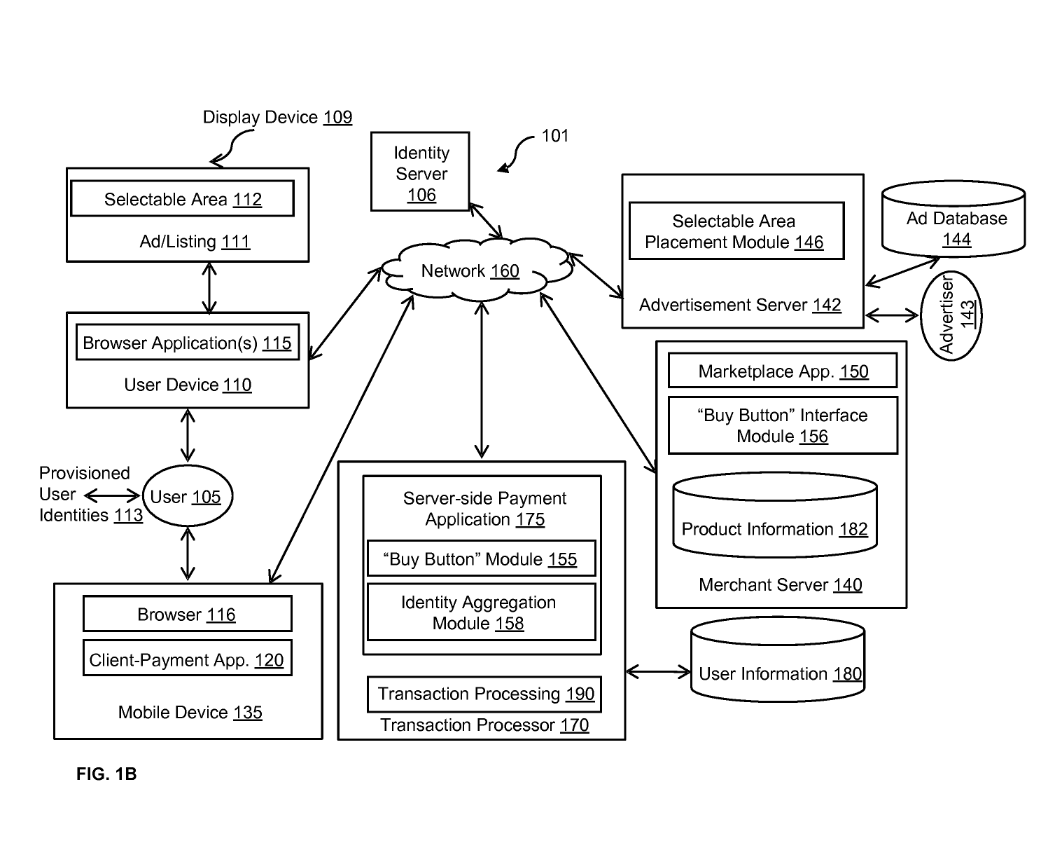

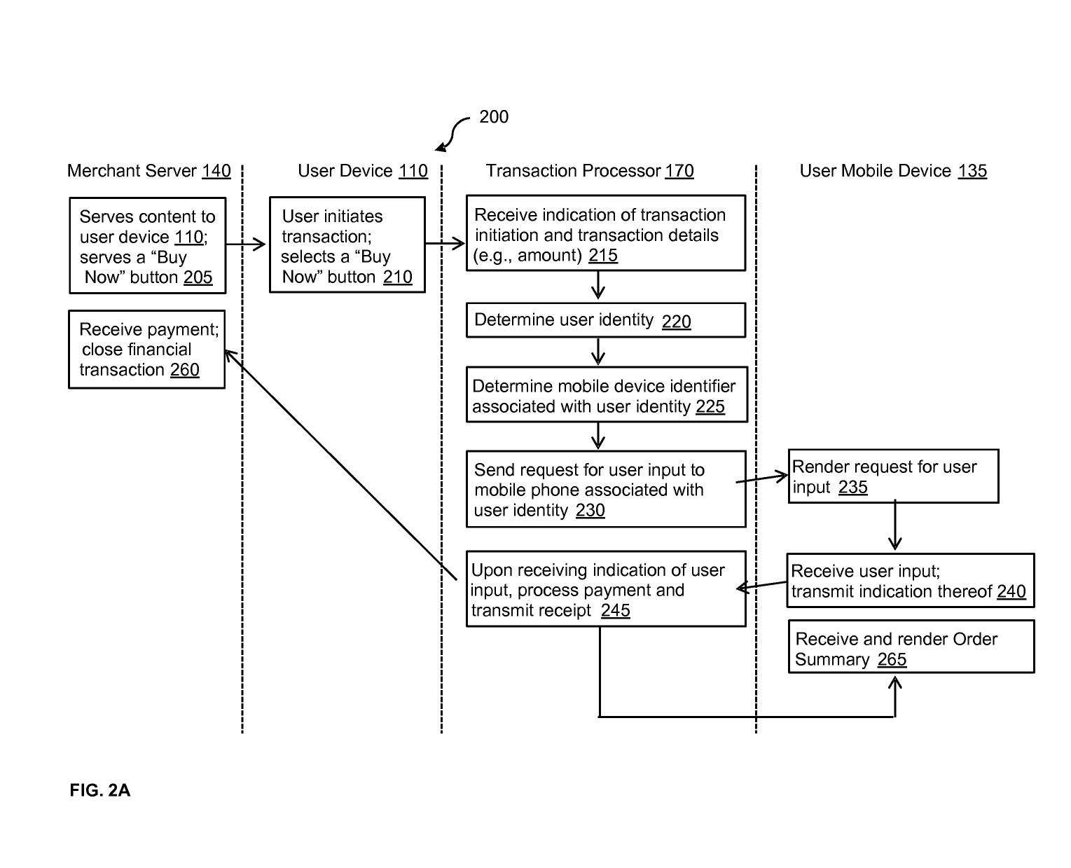

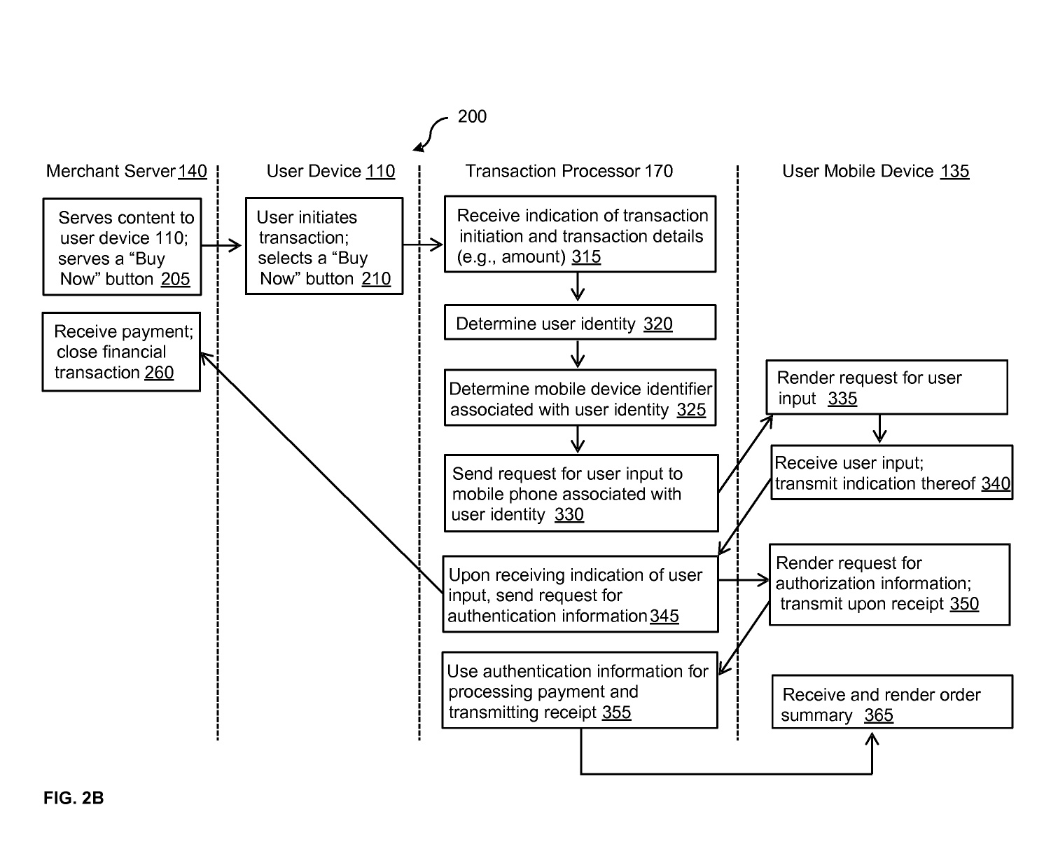

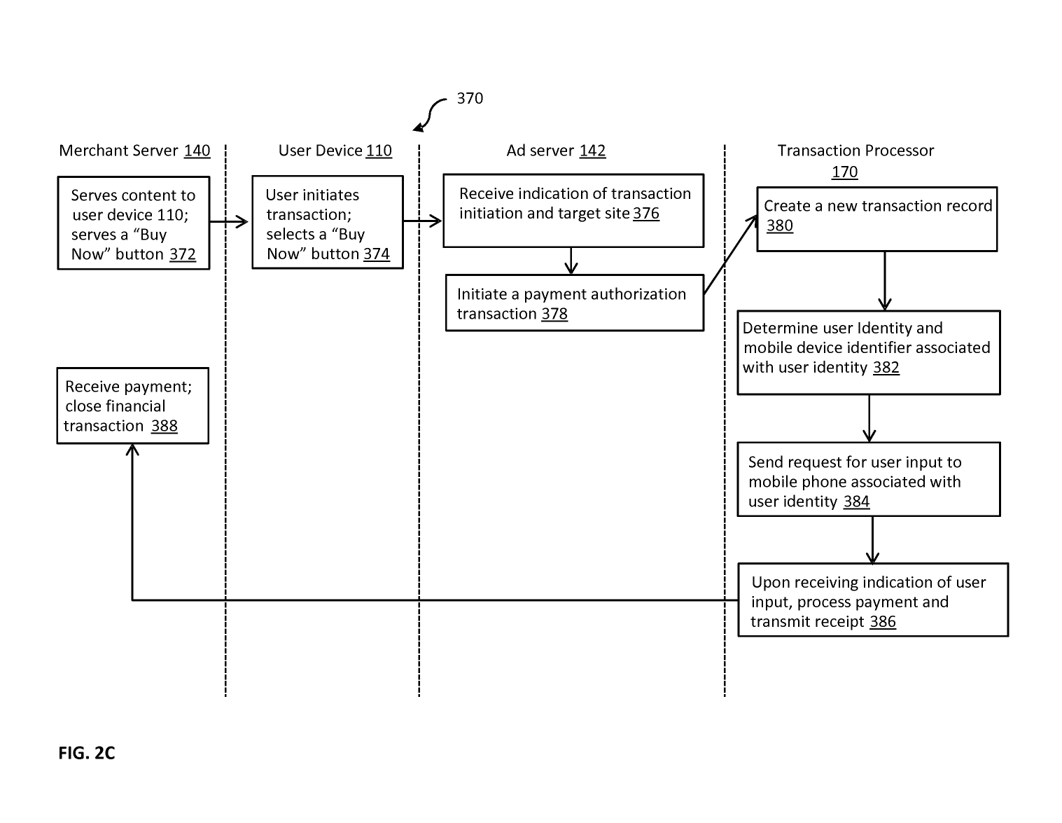

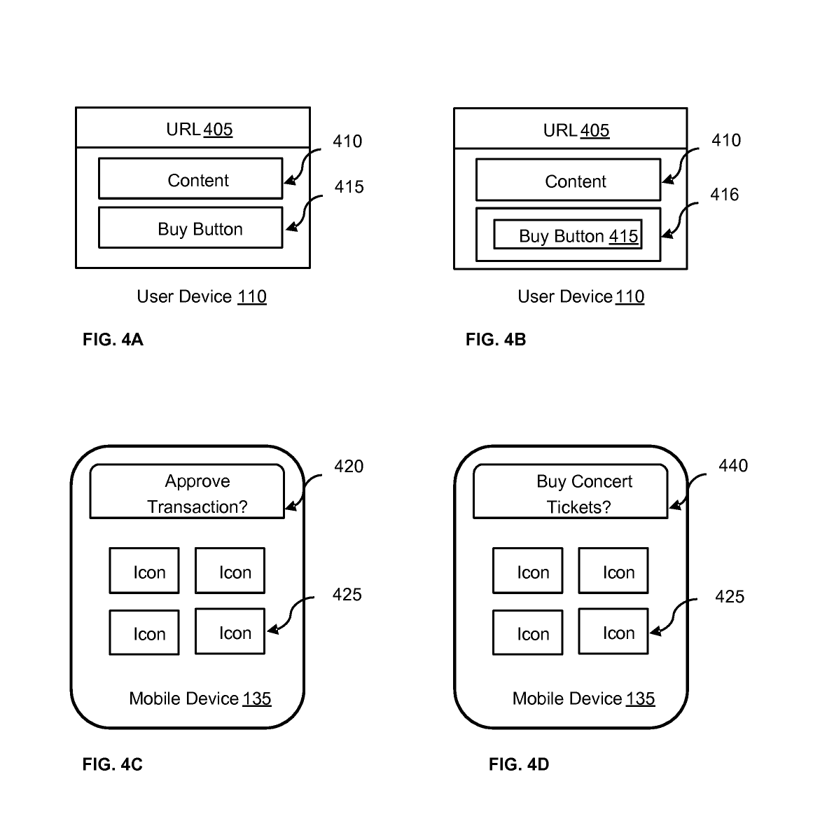

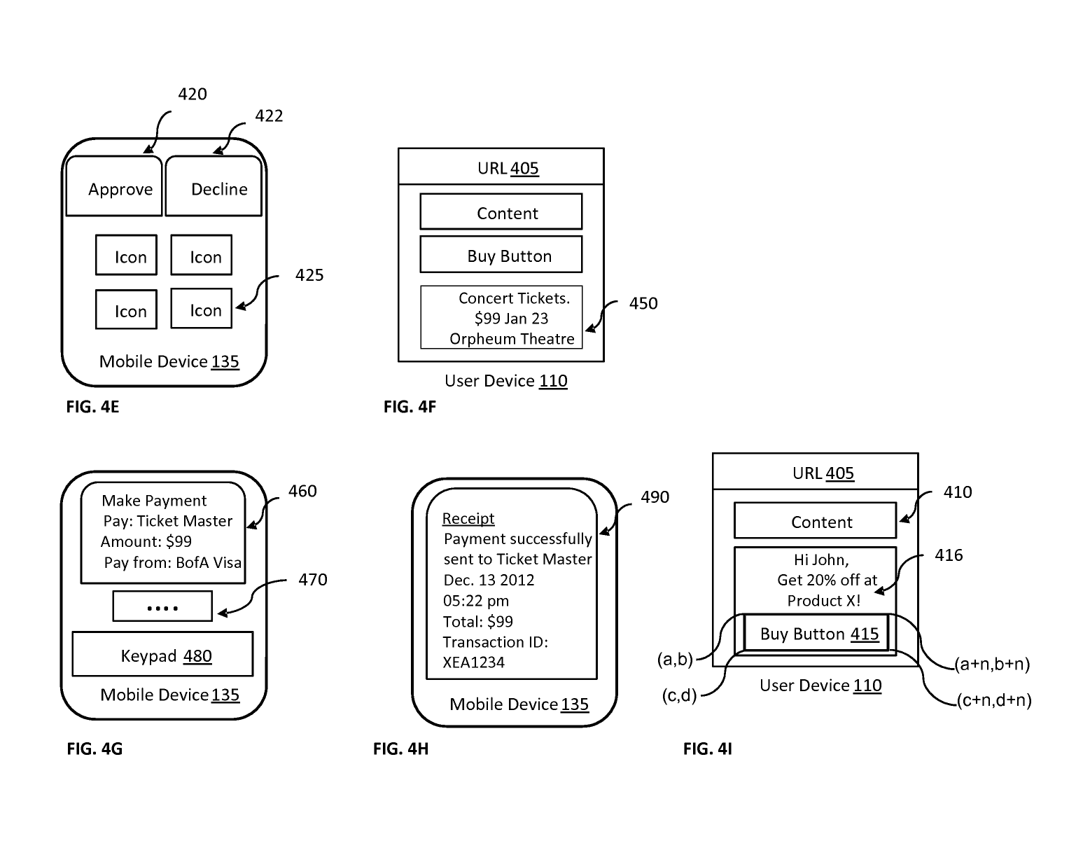

Transaction processor 170 may be maintained, e.g., by an online payment service provider which may provide payment between user 105 and the operator of merchant server 140. In this regard, transaction processor 170 may include one or more payment applications 175 which may be configured to interact with user device 110 and/or merchant server 140 over network 160 to facilitate the purchase of goods or services, communicate/display information, and send payments by user 105 of user device 110. According to an embodiment, server-side payment application 175 is also configured to communicate with client-side payment application 120 executing on mobile device 135 to enable order authorization, as discussed further with reference to FIGS. 2 and 4.

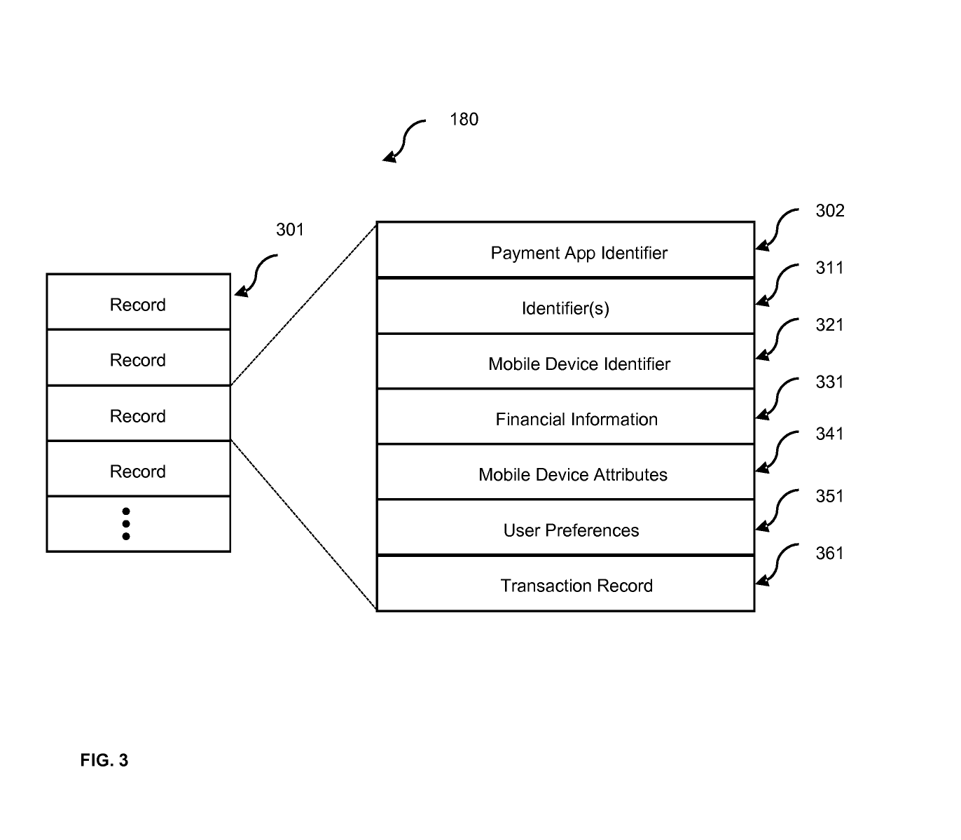

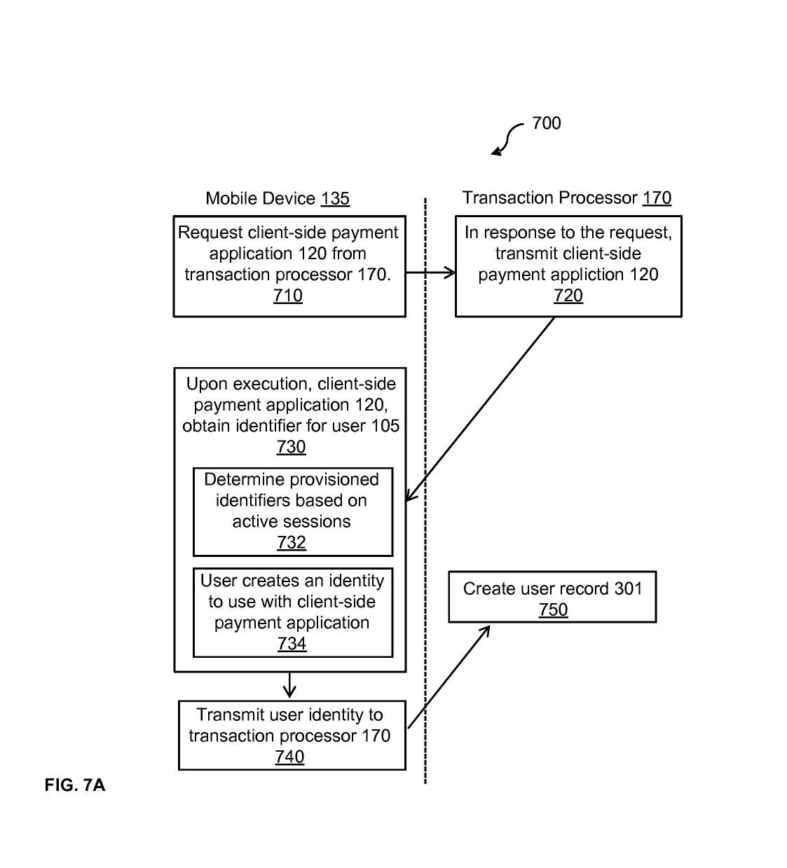

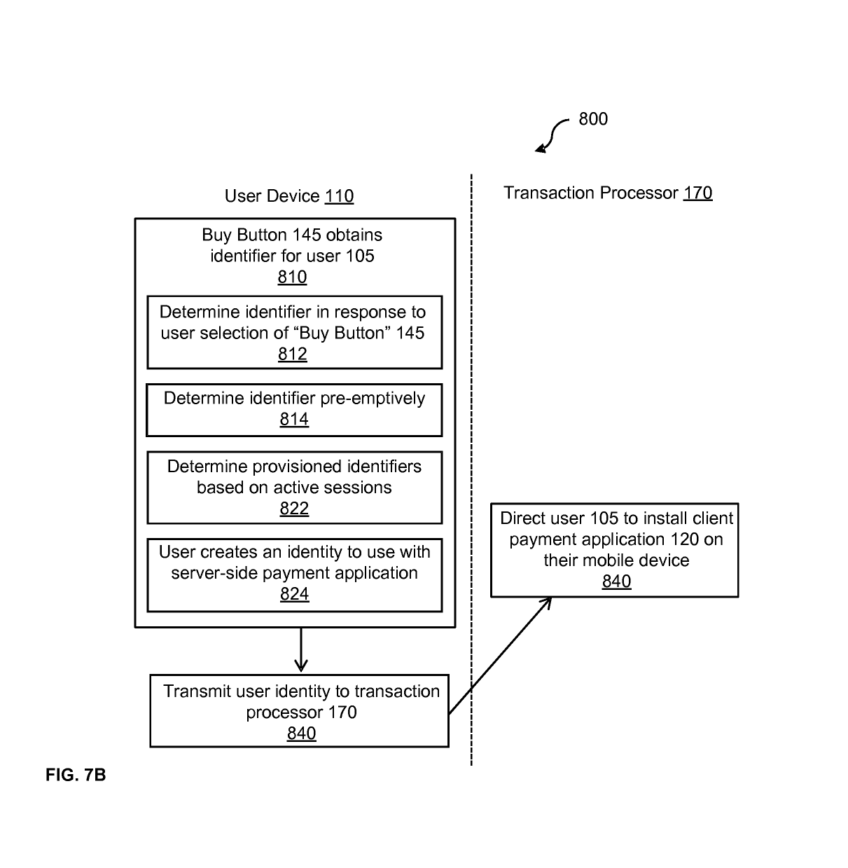

Transaction processor 170 may maintain a database of user accounts 180, each of which may include user account information associated with individual users, as discussed further with reference to FIG. 3. For example, account information may include private financial information of users of devices such as account numbers, passwords, device identifiers, user names, phone numbers, credit card information, bank information, or other financial information which may be used to facilitate online transactions by user 105. In one embodiment, this information may be provided by the user in creating an account with and registering with server-side payment application 175, e.g., when installing client-side payment application 120 on user mobile device 135, as discussed further with reference to FIGS. 7A and 7B.

Server side payment application 175 may be configured to interact with merchant server 140 during a transaction conducted using “Buy Now” button to receive information about a transaction initiated by user 105. Server side payment application 175 may further be configured to receive information from user device 110 and/or client-side payment application 120 for processing and storage in user account database 180. Payment application 175 may be further configured to determine the existence of and to manage accounts for user 105, as well as create new accounts if necessary, such as the set up, management, and use of a smart wallet for the user/mobile device.

Transaction processor 170 may further store other applications, such as a transaction processing application 190 for using funding source information, such as credit card and bank card information to process payment to merchant server 140 on behalf of user 105. For example, a product shipping module (not shown) may perform at least one product shipping-related functionality, such as causing a product to be shipped to a buyer.

Referring to FIG. 1B illustrates a block diagram of a system 101 according to an example embodiment. System 101 is the same as system 100 except that an advertisement server 142 serves advertisement content, called herein an “ad” or “listing” or “product listing” (e.g., from an advertisement content database 144) to be included in web content served by merchant server 140. As illustrated in FIG. 1B, user 105 may be viewing an ad or listing 111 on a display device 109 associated with user device 110. Ad or listing 111 may be included in a web page, email, etc and may be associated with a product. Ad or product listing 111 includes a selectable area 112, which when clicked or otherwise selected by user 105 indicates to ad server 142 that user 105 wishes to purchase the product associated with the ad. Referring for instance to FIG. 4F, buy button 415 may be embedded in or otherwise included in advertisement content 416 (e.g., advertisement, promotion, promotional message, coupon, etc.) associated with web content 410 served by advertisement server 142. This way, user 105 experiences advertisement content as a checkout method or a shopping cart. Furthermore, the user 105 does not need to navigate away from URL 405, thus reducing possibility of fraud. FIG. 4F further illustrates, in an embodiment, a set co-ordinates (a,b), (c,d), (a+n, b+n), and (c+n, d+n) that define the area that buy button 415 inhabits within ad or product listing 416. The example illustrated of a rectangular buy button 415 is merely illustrative, and buy button may take other shapes.

Referring back to FIG. 1B, in some embodiments, ad server 142 comprises a selectable area placement module 146, which determines a location of the selectable area 112 within an ad 111. In some embodiments, selectable area placement module 146 specifies which co-ordinates within an advertisement 111, the selectable area 112 is to be located. In some embodiments, selectable area placement module 146 specifies which pixels within an advertisement 111, the selectable area 112 is to be located. In some embodiments, an advertiser 143 interfaces with an ad server 142 (e.g., via an ad server interface) to define user action area specifications of the graphical ad 144. Accordingly, in some embodiments, the selectable area placement module 146 receives user input from advertiser 143 to define the location of the selectable area 112 within an ad 111.

In some embodiments, selectable area placement module 146 specifies selectable area attributes comprising of coordinates and HTML location indicators, which can then be used by computing systems to indicate an actionable area to user 105 and to record a transaction request. In one embodiment the coordinates are specified by advertiser 143 and transmitted to advertising server 142 to enable a clickable area in an advertisement.

According to an embodiment, transaction processor 170 utilizes user's mobile device 135 to complete the transaction, as further described herein.

Ad server 142 may include one or more processors, memories and other appropriate components for executing instructions such a program code and/or data stored on one or more computer readable mediums to implement various applications, data and steps described herein. For example, such instructions may be stored in one or more computer readable media such as memories or data storage devices internal and/or external to various components of system 102 and/or accessible over network 160.

Ad listing 111 may be a graphical or a video listing. It may include a user clickable element 112 to capture intent to initiate a transaction, such as to register a user, conduct a purchase transaction, and so on. In some embodiments, the ad listing 111 is an online graphical advertisement. In another example the listing could be textual.

Turning to FIG. 2A, it illustrates a process 200 for a single step order confirmation process according to an embodiment of the invention. Merchant server 140 serves content to user device 110 (205). User 105 may interact with marketplace application 150 through browser application 115 over network 160 in order to view one or more items served by merchant server 140. Merchant server 140 and/or ad server 142 may further provide a “Buy Now” button or other button inviting user 105 to initiate a transaction (205).

If user 105 wishes to purchase an item for sale or otherwise initiate a transaction, the user may select the associated “Buy Now” button (210), as illustrated further with reference to FIG. 4A. An interesting note is that the user is not required to create or log into an account associated with the merchant server 140 for the purposes of initiating the transaction. As illustrated in FIG. 4A, user 105 may be visiting a web page associated with URL 405 rendering content 410 having associated therewith “Buy Button” 415. “Buy Button” 415 may be embedded in an advertisement, e.g., a pop-up advertisement, or may be part of a twitter feed, or may be part of the content 410, email content, application data etc. In one embodiment, as further illustrated in FIG. 4B, “Buy Now” button 415 is included in an advertisement 416.

As discussed with reference to FIGS. 1A and 1B, user device 110 used to access the web page may be a personal computer (PC), a tablet, personal digital assistant (PDA), laptop computer, a smart television, and/or other types of computing devices capable of transmitting and/or receiving data over network 160. For example, a user may access an item for sale 410 or an advertisement 416 on their television while visiting a media library application, such as iTunes.

“Buy Now” button 415 is configured to facilitate the purchase by user 105 of one or more goods or services identified within content 410. When user 105 selects “Buy Button” 415, a financial transaction is initiated to transaction processor 170 over network 160 (step 215 in FIG. 2A), as discussed further herein. In some embodiments, transaction processor 170 receives an indication of transaction initiation (215), as well as some other details about the transaction. For example, a transaction amount, details about the product or services being purchased, availability of the product or services being purchased, identification of merchant server 140 providing the product or services may be transmitted to transaction processor 170. In some embodiments, the product or services being purchased may be free of charge, e.g., a coupon, a promotion, or an advertisement.

Upon receiving indication of an initiated financial transaction from “Buy Now” button, transaction processor 170 sets about to determine the identity of user 105 (220). As mentioned earlier, the user may not have entered a username and password into the merchant server's site and as such, no identifying information necessarily gets transmitted from the merchant server 140 to transaction processor 170. As such, transaction processor 170 must first determine the user associated with the initiated transaction. In one embodiment, transaction processor 170 generates an identity framework for the user utilizing user identifiers gleaned from one or more other websites with which the user 105 is currently in session with using browser 115 and for which the user 105 has provided user identifiers. As discussed above, e.g., user 105 may have logged into an account associated with a social networking site and/or an email site. Most users may leave such sessions running in the background while they conduct other business online. These logged-into sessions may be used to determine an identity associated with user 105, by identity aggregation module 107.

As can be appreciated, it is desirable to make certain that the user initiating the transaction is indeed authorized to initiate the transaction. In order to do so, upon determining an identity of the user associated with the initiated transaction, transaction processor 170 determines a mobile device identifier 136 associated with the identity (225). The mobile device identifier 136 may be previously stored in a user database 180, which may be populated, e.g., during a user registration process completed when user 105 installed client-side payment application 120 on mobile device 135. In some embodiments, identity match module 158 receives a user's provisioned identities 113 from identity aggregation module 107, retrieves a corresponding user record exists in user database 180, and retrieves the mobile device identifier 136 from the user record.

Transaction processor 170 sends a request for user input to the mobile device having an associated identifier 136 determined at step 225 (230). In one embodiment, the request for user input to the mobile device is transmitted via a Unstructured Supplementary Service Data (USSD) session. Other types of methods for communication between transaction processor 170 and mobile device 134 can also be used. In another embodiment, the request for user input to the mobile device is transmitted to client-side payment application 120, which renders a user interface, such as, illustrated in FIGS. 4C, 4D, 4E, and 4G-4I.

In one embodiment, at 230, client-side payment application 120 executing on user mobile device 134 is launched or awakened remotely. For instance, server-side payment application 175 may cause a mobile carrier network to start a USSD session.

In one embodiment, the request for user input includes a request for completion of a physical act on the mobile device by the user. The completion of the physical act provides some assurance that the user is in possession and control of the mobile device associated with the user's identity framework. In one embodiment, the request for authorization is sent to mobile device 135 via a USSD session, e.g., using Signaling System 7 (SS7) protocol. In another embodiment, the request for authorization is sent to a payment application 120 executing on mobile device 135. FIG. 4C illustrates an example of a request for user input as received on a mobile device 135. In the example illustrated in FIG. 4C, mobile device 135 has a touch screen displaying several icons 425 referring to various applications available on the mobile device 135. A message 420 is also displayed on the touch screen and represents a soft button, inviting the user of mobile device 135 to approve transaction by depressing the soft button. In the example illustrated in FIG. 4C, no information is provided in the initial message 420 about the transaction, since it can be assumed that the user has initiated the transaction (as illustrated in FIG. 4A) and therefore, has knowledge of it. In another embodiment, at least some information can be provided in the message about the transaction, as illustrated in FIG. 4D, which shows a message 440 asking the user to “Buy concert tickets.” In yet another embodiment, details about the proposed transaction are provided, e.g., in a popup 450, at the user device 110, as illustrated in FIG. 4F.

In one embodiment, the request for user input includes a request for depressing a soft button (as illustrated in FIGS. 4C and 4D). In another embodiment, the request includes a request for completion of another touch screen gesture, such as a swipe, flick, etc. In another embodiment, the request includes a request for entry of a password (e.g., associated with client-side payment application 120). In another embodiment, the request includes a request for entry of a bank ATM pin or other secret pin (as illustrated in FIG. 4G). In some embodiments, the type of physical act requested depends on the type of financial transaction and/or amount thereof. In some embodiments, the type of physical act requested depends on the type and capabilities of the mobile device 135. Thus, accordingly, if the mobile device 135 has a touch screen capable of receiving touch input, a requested physical act may include a swipe. Such a physical act request would not be requested of a mobile device 135 that does not have a touch screen. In other embodiments, the mobile device 135 may use biometric recognition capabilities to verify the user's identity, such as through audio capabilities (e.g., voice recognition) or image/video capture capabilities (e.g., facial recognition). The captured audio or image/video is processed through recognition software to identify the user in possession of the mobile device 135.

Client-side payment application 120 executing on the user mobile device 135 renders the request for user input (235). The rendering may include display of the request for authorization. In other embodiments, the rendering may include a sound alert.

User mobile device 135 receives user input corresponding to the request for authorization (240). User input may include the user depressing a soft button, completing a touch screen gesture, entering a password, entering a bank ATM pin, a secret pin, recording a user's voice, capturing an image of a user's facial features, etc. User mobile device 135 (and/or payment application 120) transmits (either via push or pull) an indication of user input to transaction processor 170 (240). In some embodiments, depending on the sensitivity of the nature of information being transmitted, it may be protected, e.g., using encryption techniques. Client-side payment application 120 executing on the user mobile device 135 may process the user input, e.g., hash and salt the user-entered password or pin, and transmit the hashed and salted password to transaction processor 170, for instance via a USSD session.

In some embodiments, user input is valid for a limited duration. Accordingly, if the user input is not received at the transaction processor 170 within a certain predetermined amount of time, transaction processor 170 deems the transaction unsuccessful. If the user 105 does not provide the input requested at step 235, either in a timely fashion or not at all, the transaction processor 170 deduces that the transaction is either not initiated by user 105 or the user 105 has changed their mind or the user 105 initiated the transaction by mistake. Transaction processor 170 cancels the transaction, and may send a cancellation message to merchant server 140 and/or may send a message, such as a fraud alert to the user 105, e.g., via an SMS to mobile device 135.

In some embodiments, in addition to providing provide an option for the user to approve the transaction (such as, illustrated in FIGS. 4C and 4D), the request for user input rendered at 235 includes an option to cancel the transaction (as illustrated in FIG. 4E as button 422). If the user 105 selects the cancel transaction option at step 235, this information is transmitted to transaction processor 170 and the transaction is cancelled.

Transaction processor 170 uses the received user input to authorize the transaction (245), and to make payment to the merchant server 140. The user input may be compared to information stored, e.g., in user account information 180, or may be sent to a third party (such as, a bank card or credit card issuing authority) for authorization.

Merchant server 140 receives the payment from transaction processor 170 (e.g., via a bank or other intermediary) and processes the transaction (e.g., ships purchased goods). In one embodiment, transaction processor 170 also provides user details, e.g., shipping preferences to merchant server 140, as obtained from user account information 180. Transaction processor 170 transmits a transaction confirmation to mobile device 135, which is then rendered at mobile device 135 (265). FIG. 4H illustrate an example of a transaction confirmation 490 being displayed at mobile device 135. Transaction confirmation 490 may contain such details as transaction amount, transaction date and time, a transaction record number, payment source, etc. Although not illustrated in FIG. 4H, user may be provided with options with respect to transaction confirmation 490, such as to save, print, email the receipt, etc.

Thus, process 200 enables a single step authorization of a transaction initiated using a user device 110 and authorized using user mobile device 135. Note that no authorization or other input was required from the user 105 at user device 110 and only input requested was at user's mobile device 135 (after initiation of transaction at user device 110).

Referring now to FIG. 2B, it illustrates a process 300 for a dual step order confirmation process according to an example embodiment. Process 300 is similar to process 200, except after receipt of an initial user input from user mobile device 135 (at step 330), transaction processor 170 sends a request for authorization to mobile device 135 (345). In some embodiments, the first request for user input (at step 330) may include a request for a simple task, e.g., to signify that the user is in possession of the mobile device 135, while the second request for user input (at step 345) may request sensitive user information. The sensitive user information can be matched against stored information for the user or otherwise used for authorization. For example, a first request of user input may require the user to depress a soft button (e.g., depress a “Approve Transaction” button, as illustrated in FIGS. 4C and 4D), while the second request may require the user to enter a pin or password. In one embodiment, a hash of the pin or password is transmitted by the mobile device as indication of authorization. If no indication of user input is received (at 355), the transaction is cancelled, and no request for authentication information is sent at step 345. Turning to FIG. 4G, it illustrates an example of an authorization process requesting user of mobile device 135 to provide a pin 470 using keypad 480 to approve a transaction in addition to providing details 460 about the transaction.

Transaction processor 170 uses the received authorization information to authorize the transaction (355), and to make a payment to the merchant server 140. The user authorization information may be compared to information stored, e.g., in user account information 180, or may be sent to a third party (such as, a bank card or credit card issuing authority) for authorization. In one embodiment, no payment may be due to the merchant server 140, e.g., when a product being purchased is free of charge. However, the process 200 may be used to confirm completion of the transaction.

In some embodiments, the number of physical acts (one as discussed with reference to FIG. 2A and two as discussed with reference with FIG. 2B) requested depend on the type of financial transaction and/or amount thereof and/or user preferences. Thus, a user 105 may cause a preference to be stored, e.g., in a user account maintained with transaction processor 170 that the user wishes dual-step authorization for purchases over a particular amount, or for transactions with a particular merchant, etc.

In the system and methods illustrated in FIGS. 1A, 1B and 2A-C respectively, the client device 110 and mobile device 135 are illustrated as two separate devices. In another embodiment, the mobile device 135 alone is sufficient. Accordingly, user 105 may use browser application 116 on mobile device 135 to access content served by merchant server 140, and transaction processor 170 may use the mobile device 135 for user authorization.

Referring to FIG. 2C, it illustrates a flow chart of a method 370 for completing a transaction that is initiated from an ad or listing according to certain embodiments.

Advertisement server 142 outputs an ad/listing for serving to user device 110. The ad/listing may be provided to the merchant server 140 for serving to the user device 110 (372). In one embodiment, selectable area placement module 146 specifies which real estate (e.g., co-ordinates and/or pixels) of the advertisement are to be inhabited by a selectable area, e.g., called the Buy Button. This real estate information can be useful to determine revenue from the advertisement. For example, a selection of the selectable are within ad/listing click determines that the user attempted to purchase the item promoted by the advertisement, which provides a more accurate way of monetizing the advertisement than, say CPV (cost of advertisement per view). An example of an ad is illustrated in FIG. 4F.

If user 105 clicks on or otherwise selects the pixels inhabited by the Buy Button (374), advertisement server 142 receives an indication of transaction initiation and target site (376). In some embodiments, Ad server 142 initiates a payment authorization transaction over network 160 (378), which prompts transaction processor 170 to creates a new transaction record (380). Identity aggregation module 107 determines one or more provisioned user identities 113 (382), and communicates the information to transaction processor 170, where identity match module 158 determines if an identity received from identity aggregation module 107 matches an identity stored in user information database. If a provisioned Identity 113 matches an ID in a user record in user information database 180, a transaction or payment authorization may be initiated with the mobile device 135 associated with the user record (384), as described with reference to FIGS. 2A and 2B (225 and 230).

Turning to FIG. 3, it is a block diagram of an example database structure 180. Database structure 180 contains a set of user account records. A respective user account record 301 may include such information as: (i) an identifier 302 that uniquely identifies the (instance of) client-side payment application 120, (ii) one or more user identifiers 311 associated with the user (e.g., user's login user name and password associated with a social networking site, user's email login user name and password, user's account user name and password associated with an online merchant, etc.), (iii) a mobile device identifier 321 associated with the user, such as a mobile phone number, an IDEN number, etc. (iv) private financial information 331 of the user, such as credit card information, bank information, or other financial information which may be used to facilitate online transactions by user, (v) attributes and capabilities 341 of the mobile device associated with the device number 321, (vi) user preferences 351 (such as, shipping address, etc.), and (vii) transaction records 361 (such as, transaction amounts, dates, etc.) associated with the user record 301.

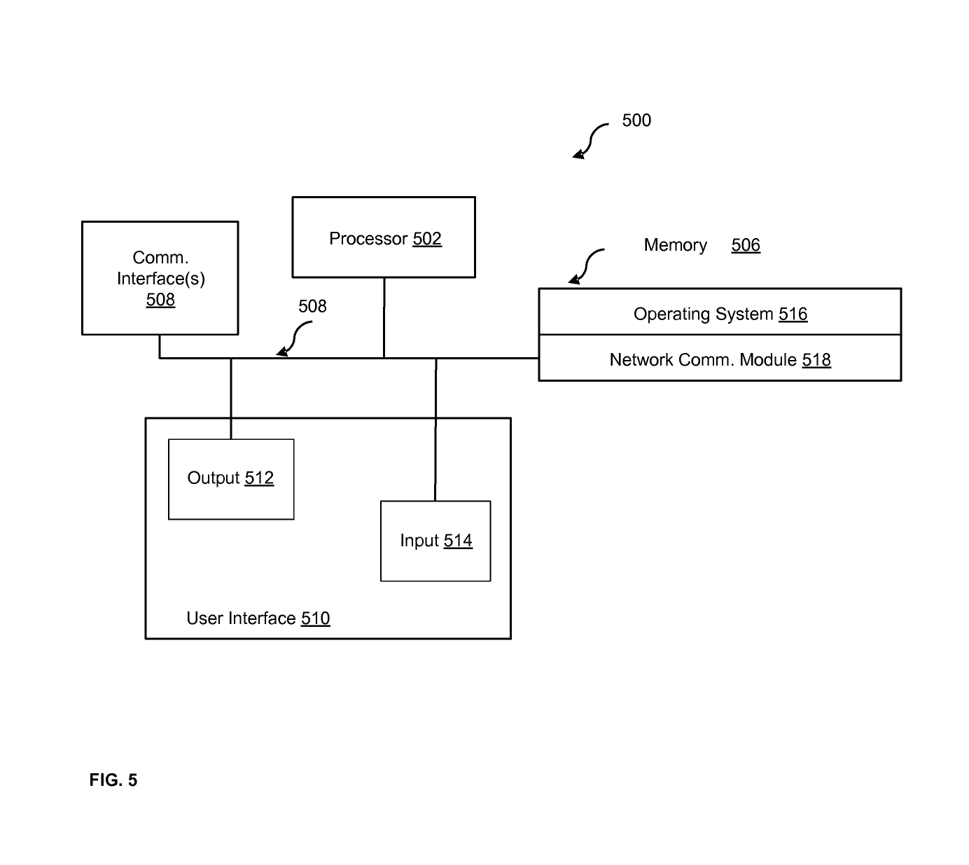

Referring now to FIG. 5, it is a block diagram of an exemplary computing device 500, which can be used as any one of user device 110, merchant server 140 and transaction processor 170. In one embodiment computing device 500 typically includes one or more processing units (CPUs) 502, one or more network or other communications interfaces 508, memory 506, and one or more communication buses 508 for interconnecting these components. The communication buses 508 may include circuitry (sometimes called a chipset) that interconnects and controls communications between system components. Computing device 500 may include a user interface 510 comprising an output (e.g. display) device 512 and an input device (e.g., keyboard) 514.

Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 506 may optionally include one or more storage devices remotely located from the CPU(s) 502. Memory 506, or one or more of the storage devices (e.g., one or more non-volatile storage devices) in memory 506, includes a computer readable storage medium. In some embodiments, memory 506 or the computer readable storage medium of memory 506 stores the following programs, modules and data structures, or a subset thereof: an operating system 516 that includes procedures for handling various basic system services and for performing hardware dependent tasks; a network communication module 518 that is used for connecting computing device 500 to other computers via the one or more communication network interfaces 508 and one or more communication networks, such as the Internet, other wide area networks, local area networks, metropolitan area networks, and so on. In case of client device 110, memory 506 may further store other applications, such as browser application 115, word processing applications, etc. In case of merchant server 140, memory 506 may further store a marketplace application 150 and “buy button” interface module 156. In case of transaction processor 170, memory 506 may further store server-side payment application 175, an identity match module 158, database of user accounts 180 (which of course may be stored externally), transaction processing application 190, and so on. In case of ad server 142, memory 506 may further store selectable area placement module 146 for defining a location of the selectable area 112 within an ad 111, e.g., based on input from advertiser 143. In case of identity server 106, memory 506 may further store identity aggregation module 107.

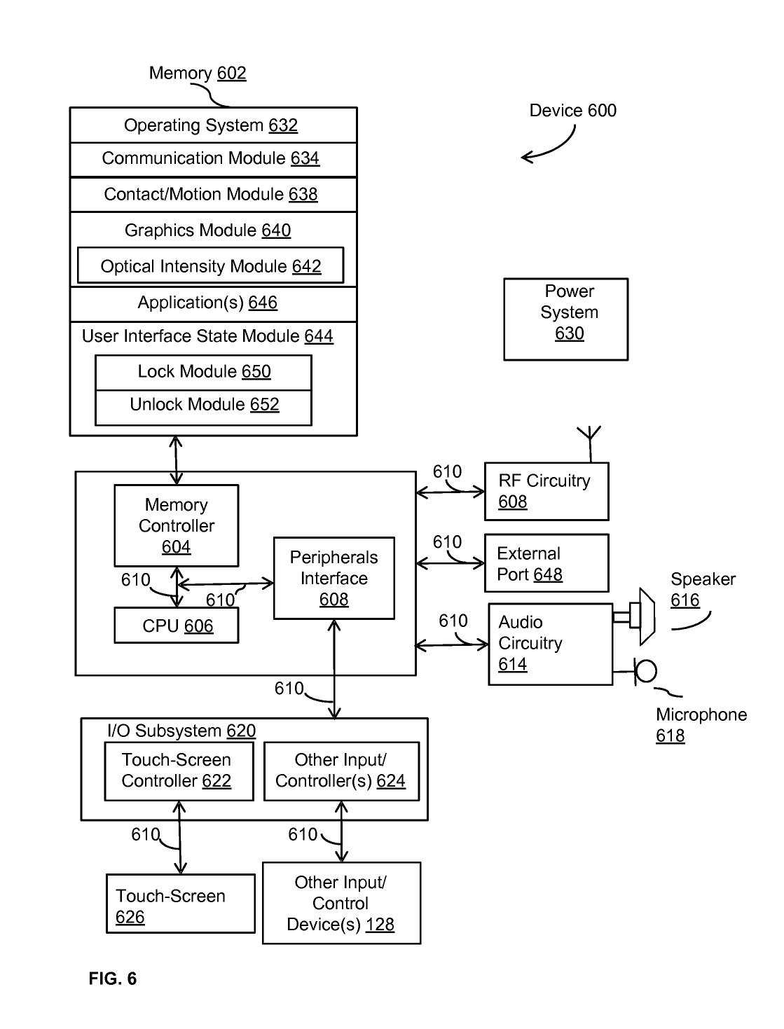

FIG. 6 illustrates an example portable electronic device 600, which can function as user mobile device 135. The device 600 includes a memory 602, a memory controller 104, one or more processing units (CPU's) 606, a peripherals interface 608, RF circuitry 612, audio circuitry 614, a speaker 616, a microphone 618, an input/output (I/O) subsystem 620, a touch screen 626, other input or control devices 628, and an external port 648. These components communicate over the one or more communication buses or signal lines 610. It should be appreciated that the device 600 is only one example of a portable electronic device 600, and that the device 600 may have more or fewer components than shown, or a different configuration of components. The various components shown in FIG. 6 may be implemented in hardware, software or a combination of both hardware and software, including one or more signal processing and/or application specific integrated circuits.

The memory 602 may include high speed random access memory and may also include non-volatile memory, such as one or more magnetic disk storage devices, flash memory devices, or other non-volatile solid state memory devices. In some embodiments, the memory 602 may further include storage remotely located from the one or more processors 606, for instance network attached storage accessed via the RF circuitry 612 or external port 648 and a communications network (not shown) such as the Internet, intranet(s), Local Area Networks (LANs), Wide Local Area Networks (WLANs), Storage Area Networks (SANs) and the like, or any suitable combination thereof. Access to the memory 602 by other components of the device 600, such as the CPU 606 and the peripherals interface 608, may be controlled by the memory controller 604.

The peripherals interface 608 couples the input and output peripherals of the device to the CPU 606 and the memory 602. The one or more processors 606 run various software programs and/or sets of instructions stored in the memory 602 to perform various functions for the device 600 and to process data.

In some embodiments, the peripherals interface 608, the CPU 606, and the memory controller 604 may be implemented on a single chip, such as a chip 611. In some other embodiments, they may be implemented on separate chips.

The RF (radio frequency) circuitry 612 receives and sends electromagnetic waves. The RF circuitry 612 converts electrical signals to/from electromagnetic waves and communicates with communications networks and other communications devices via the electromagnetic waves. The RF circuitry 612 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 612 may communicate with the networks, such as the Internet, also referred to as the World Wide Web (WWW), an Intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry 614, the speaker 616, and the microphone 618 provide an audio interface between a user and the device 600. The audio circuitry 614 receives audio data from the peripherals interface 608, converts the audio data to an electrical signal, and transmits the electrical signal to the speaker 616. The speaker converts the electrical signal to human-audible sound waves. The audio circuitry 614 also receives electrical signals converted by the microphone 616 from sound waves. The audio circuitry 614 converts the electrical signal to audio data and transmits the audio data to the peripherals interface 608 for processing. Audio data may be may be retrieved from and/or transmitted to the memory 602 and/or the RF circuitry 612 by the peripherals interface 608. In some embodiments, the audio circuitry 614 also includes a headset jack (not shown). The headset jack provides an interface between the audio circuitry 614 and removable audio input/output peripherals, such as output-only headphones or a headset with both output (headphone for one or both ears) and input (microphone).

The I/O subsystem 620 provides the interface between input/output peripherals on the device 600, such as the touch screen 626 and other input/control devices 628, and the peripherals interface 608. The I/O subsystem 620 includes a touch-screen controller 622 and one or more input controllers 624 for other input or control devices. The one or more input controllers 624 receive/send electrical signals from/to other input or control devices 628. The other input/control devices 628 may include physical buttons (e.g., push buttons, rocker buttons, etc.), dials, slider switches, sticks, and so forth.

The touch screen 626 provides both an output interface and an input interface between the device and a user. The touch-screen controller 622 receives/sends electrical signals from/to the touch screen 626. The touch screen 626 displays visual output to the user. The visual output may include text, graphics, video, and any combination thereof. Some or all of the visual output may correspond to user-interface objects, further details of which are described below.

The touch screen 626 also accepts input from the user based on haptic and/or tactile contact. The touch screen 626 forms a touch-sensitive surface that accepts user input. The touch screen 626 and the touch screen controller 622 (along with any associated modules and/or sets of instructions in the memory 602) detects contact (and any movement or break of the contact) on the touch screen 626 and converts the detected contact into interaction with user-interface objects, such as one or more soft keys, that are displayed on the touch screen. In an exemplary embodiment, a point of contact between the touch screen 626 and the user corresponds to one or more digits of the user. The touch screen 626 may use LCD (liquid crystal display) technology, or LPD (light emitting polymer display) technology, although other display technologies may be used in other embodiments. The touch screen 626 and touch screen controller 622 may detect contact and any movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 626. However, the touch screen 626 displays visual output from the portable device, whereas touch sensitive tablets do not provide visual output. The touch screen 626 may have a resolution in excess of 600 dpi. In an exemplary embodiment, the touch screen 626 may have a resolution of approximately 668 dpi. The user may make contact with the touch screen 626 using any suitable object or appendage, such as a stylus, finger, and so forth.

In some embodiments, in addition to the touch screen, the device 600 may include a touchpad (not shown) for activating or deactivating particular functions. In some embodiments, the touchpad is a touch-sensitive area of the device that, unlike the touch screen, does not display visual output. The touchpad may be a touch-sensitive surface that is separate from the touch screen 626 or an extension of the touch-sensitive surface formed by the touch screen 626.

The device 600 also includes a power system 630 for powering the various components. The power system 630 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

In some embodiments, the software components include an operating system 632, a communication module (or set of instructions) 634, a contact/motion module (or set of instructions) 638, a graphics module (or set of instructions) 640, a user interface state module (or set of instructions) 644, and one or more applications (or set of instructions) 646.

The operating system 632 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 634 facilitates communication with other devices over one or more external ports 648 and also includes various software components for handling data received by the RF circuitry 612 and/or the external port 648. The external port 648 (e.g., Universal Serial Bus (USB), FIREWIRE, etc.) is adapted for coupling directly to other devices or indirectly over a network (e.g., the Internet, wireless LAN, etc.).

The contact/motion module 638 detects contact with the touch screen 626, in conjunction with the touch-screen controller 622. The contact/motion module 638 includes various software components for performing various operations related to detection of contact with the touch screen 622, such as determining if contact has occurred, determining if there is movement of the contact and tracking the movement across the touch screen, and determining if the contact has been broken (i.e., if the contact has ceased). Determining movement of the point of contact may include determining speed (magnitude), velocity (magnitude and direction), and/or an acceleration (including magnitude and/or direction) of the point of contact. In some embodiments, the contact/motion module 626 and the touch screen controller 622 also detects contact on the touchpad.

The graphics module 640 includes various known software components for rendering and displaying graphics on the touch screen 626. Note that the term “graphics” includes any object that can be displayed to a user, including without limitation text, web pages, icons (such as user-interface objects including soft keys), digital images, videos, animations and the like.

In some embodiments, the graphics module 640 includes an optical intensity module 642. The optical intensity module 642 controls the optical intensity of graphical objects, such as user-interface objects, displayed on the touch screen 626. Controlling the optical intensity may include increasing or decreasing the optical intensity of a graphical object. In some embodiments, the increase or decrease may follow predefined functions.

The user interface state module 644 controls the user interface state of the device 600. The user interface state module 644 may include a lock module 650 and an unlock module 652. The lock module detects satisfaction of any of one or more conditions to transition the device 600 to a user-interface lock state and to transition the device 600 to the lock state. The unlock module detects satisfaction of any of one or more conditions to transition the device to a user-interface unlock state and to transition the device 600 to the unlock state.

The one or more applications 630 can include any applications installed on the device 600, including without limitation, a browser, address book, contact list, email, instant messaging, word processing, keyboard emulation, widgets, JAVA-enabled applications, encryption, digital rights management, voice recognition, voice replication, location determination capability (such as that provided by the global positioning system (GPS)), a music player (which plays back recorded music stored in one or more files, such as MP3 or AAC files), etc. Client-side payment application 120 may also be installed on device 600.

FIG. 7A illustrates a block diagram of an example registration process 700 used to create a user identity record 301 according to some embodiments. In one embodiment, process 700 begins with the user requesting client-side payment application 120 from transaction processor 170 for execution on mobile device 135 (710). Transaction processor 170 pushes or otherwise provisions client-side payment application 120 to mobile device 135, e.g., using a mobile communications network (720). Once executing on mobile device 135, client-side payment application 120 obtains an identifier associated with user 105 (730). In one embodiment, client-side payment application 120 does not require user 105 to create or otherwise log in to client-side payment application 120. Instead, client-side payment application 120 determines provisioned identifiers for the user 105 (732) based on the user's active sessions, e.g., with social networking accounts, email accounts, etc., running on mobile device 135. In another embodiment, where the user 105 does not participate in such sessions, e.g., with social networking accounts, email accounts, etc., the user 105 may create a user name and password with which to log into client-side payment application 120 (734), and this user name and password can be used as the identifier associated with user 105. Client-side payment application 120 transmits the one or more identifiers for the user 105 to transaction processor 170, which creates a record 301 for user 105 associating the mobile device identifier for mobile device 135 and the one or more user identifiers together (750). Transaction processor 170 may subsequently modify or update user record 301 based e.g., on transactions completed by the user 105, or as user identifier 311 data changes. User 105 may optionally provide user preference data (e.g., preferred shipping address, preferred payment method information, etc.) during (or subsequent to) the registration process.

FIG. 7B illustrates a block diagram of a process 800 which may lead up to process 700 discussed with reference to FIG. 7A. In particular, process 800 may lead to the user 105 requesting client-side payment application 120 from transaction processor 170 for execution on mobile device 135 (710).

Process 800 starts with executable code within “Buy button” 415 obtaining one or more identifiers associated with user 105 (810). In one embodiment, “Buy Button” 415 obtains the identifiers in response to the user 105 selecting a “Buy Button” 415 (810) to purchase an object for sale, e.g., as part of an advertisement, or a twitter feed, or a retail store, etc., using user device 110 (812). In another embodiment, “Buy Button” 415 obtains the identifiers even before the user 105 selects the “Buy Button” 415 in a pre-emptive manner (814). In an embodiment in which “Buy Button” 415 is embedded or otherwise integrated into advertisement content (e.g., content 416), pre-emptive identification of the user can be used to personalize the advertisement content (e.g., 416), e.g., by displaying a greeting to the user 105. An example screenshot, as illustrated in FIG. 41, advertisement content 416 includes Buy Button 415, and a personalized promotional message 418 to user 105.

In one embodiment, the user is not required to create or otherwise log into an account associated with the provider of the object for sale. Instead, “Buy button” 415 or an external identity provider as requested by “Buy Button” 415 determines provisioned identifiers for the user 105 (822) based on the user's active sessions, e.g., with social networking accounts, email accounts, etc., running on user device 110. In another embodiment, when there are no such active sessions, the user 105 may provide a user name and password with which to log into an account with server-side payment application 120 (824), and this user name and password can be used as the identifier associated with user 105.

Code within “Buy Button” 415 transmits the user identifier to transaction processor 170 (830), which performs a lookup to see if there is a user record 301 in database 180. If no record exits, user 105 is requested to register with Server-side payment application 175 and install client-payment application 120 on mobile device 135.

While the above description contains many specifics and certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art, as mentioned above. The invention includes any combination or sub-combination of the elements from the different species and/or embodiments disclosed herein.

1. A method for enabling a financial transaction, comprising:
at a transaction processing server:
receiving an indication from a user to conduct the financial transaction;
in response to receiving the indication from the user, determining an identity associated with the user;
determining a mobile device identifier associated with the determined identity, the mobile device identifier identifying a mobile device authorized by the user for completing the financial transaction;
upon determining the mobile device identifier, sending a request to the mobile device associated with the mobile device identifier for the user to provide user input into the mobile device;
receiving, from the mobile device, an indication that the requested user input was provided at the mobile device; and
in response to receiving the indication, enabling the financial transaction.

2. The method of claim 1, wherein the request for user input includes a request for depressing a soft key.

3. The method of claim 1, wherein the request for user input includes a request for completion of a touch screen gesture.

4. The method of claim 1, wherein the request for user input includes a request for entry of a password.

5. The method of claim 1, wherein the request for user input includes a request for entry of a secret pin.

6. The method of claim 1, wherein the identity is determined based on a user identifier associated with a current user session with a respective web site.

7. The method of claim 6, further comprising:
in response to receiving the indication that the requested user input was provided at the mobile device, transmitting a request for user identity verification and transaction authorization to the mobile device; and
in response to receiving a user response to the user identity verification and transaction authorization request, processing the transaction.

8. The method of claim 7, wherein the request for user identity verification and transaction authorization includes a request for entry of a password.

9. The method of claim 7, wherein the request for user identity verification and transaction authorization includes a request for entry of a secret pin.

10. The method of claim 7, wherein the request for user input includes a request for completion of a touch screen gesture and the request for user identity verification and transaction authorization includes a request for entry of a password.

11. The method of claim 7, wherein the request for user identity verification and transaction authorization includes a request for biometrics authentication information.

12. A method for enabling a financial transaction, comprising:
at a transaction processing server:
receiving an indication from a user to conduct the financial transaction;
in response to receiving the indication from the user, determining an identity associated with the user;
sending a first request to a mobile device associated with the determined identity to provide user input into the mobile device, wherein the first request includes a request for completion of a physical act on the mobile device by the user;
receiving an indication that the first request was completed at the mobile device;
sending a second request to the mobile device associated with the identity to provide user input, wherein the second request includes a request for entry of user authentication information into the mobile device; and
in response to receiving the user information, enabling the financial transaction.

13. The method of claim 12, wherein the first request for user input includes a request for depressing a soft key.

14. The method of claim 12, wherein the first request for user input includes a request for completion of a touch screen gesture.

15. The method of claim 12, wherein the second request for user input includes a request for entry of a password.

16. The method of claim 12, wherein the second request for user input includes a request for biometrics authentication information.

17. The method of claim 12, wherein the identity is determined based on a user identifier associated with a current user session with a respective web site.

18. The method of claim 12, wherein the request for user input includes a request for completion of a touch screen gesture and the request for user identity verification and transaction authorization includes a request for entry of a password.

19. A method for enabling a financial transaction requested by a user, comprising:
at a server,
transmitting web content for rendering on a user device by a browser application executing at the user device, wherein an identity of the user is unknown, the web content including:
information about one or more products, and
checkout module for providing a user interface to enter an indication that
a user wishes to conduct the financial transaction;
receiving the indication for the user to conduct the financial transaction from the user device; and
in response to receiving the indication from the user, authorizing the financial transaction using a mobile device associated with the user, the authorizing including:
determining the identity associated with the user,
determining a mobile device identifier associated with the determined identity, the mobile device identifier identifying a mobile device authorized by the user for completing the financial transaction,
upon determining the mobile device identifier, sending a request to the mobile device associated with the mobile device identifier for the user to provide user input into the mobile device,
receiving, from the mobile device, an indication that the requested user input was provided at the mobile device, and
in response to receiving the indication, enabling the financial transaction.

20. The method of claim 19, wherein the request for user input includes a request for depressing a soft key.

21. The method of claim 19, wherein the request for user input includes a request for completion of a touch screen gesture.

22. The method of claim 19, wherein the request for user input includes a request for entry of a password.

23. The method of claim 19, wherein the request for user input includes a request for entry of a secret pin.

24. The method of claim 19, wherein the identity is determined based on one a user identifier associated with a current user session with a respective web site.

25. The method of claim 24, further comprising:
in response to receiving the indication that the requested user input was provided at the mobile device, transmitting a request for user identity verification and transaction authorization to the mobile device; and
in response to receiving a user response to the user identity verification and transaction authorization, processing the transaction.

26. The method of claim 25, wherein the request for user identity verification and transaction authorization includes a request for entry of a password.

27. The method of claim 25, wherein the request for user identity verification and transaction authorization includes a request for entry of a secret pin.

28. The method of claim 25, wherein the request for user input includes a request for completion of a touch screen gesture and the request for transaction authorization includes a request for entry of a password.

29. The method of claim 25, wherein the request for user identity verification and transaction authorization includes a request for biometrics authentication.

30. The method of claim 19, wherein the web content further includes advertisement content, and wherein the advertisement content comprises the checkout module.
